(19) United States
(12) Patent Application Publication
(10) Pub. No.: US 2026/0021497 A1
(43) Pub. Date: Jan. 22, 2026

(54) ADJUSTABLE INLET ASSEMBLY FOR SAND SEPARATOR

(71) Applicant: ENERCORP ENGINEERED SOLUTIONS INC., CLAGARY (CA)

(72) Inventors: Ryan Thomas Bowley, Calgary (CA); Brent James William Coombe, Calgary (CA)

(21) Appl. No.: 19/341,283

(22) Filed: Sep. 26, 2025

Related U.S. Application Data
(63) Continuation-in-part of application No. 17/731,385, filed on Apr. 28, 2022.
(60) Provisional application No. 63/181,631, filed on Apr. 29, 2021.

(51) Int. Cl. B04C 5/04

(52) U.S. Cl. CPC B04C 5/04

(57) ABSTRACT

An adjustable inlet assembly for a separator includes a nozzle positioned in an inlet of a cyclone housing. The adjustable inlet assembly also includes an inlet housing coupled to the cyclone housing and sealing therewith around the inlet. The adjustable inlet assembly also includes a movable rod disposed at least partially in the inlet housing. The movable rod is configured to move between a first position in which the movable rod at least partially obstructs fluid flow in the nozzle, and a second position in which the movable rod does not obstruct fluid flow in the nozzle.

### CROSS-REFERENCE TO RELATED APPLICATIONS

This application is a Continuation-in-Part of U.S. patent application Ser. No. 17/731,385, filed Apr. 28, 2022, which claims priority to U.S. Provisional Patent Application No. 63/181,631, filed on Apr. 29, 2021, both of which are incorporated herein by reference in their entirety.

### BACKGROUND

Hydraulic fracturing is a well-treatment process in which preferential flow paths for hydrocarbons are established in a subterranean rock formation by pumping a fluid at high pressures into a well to initiate fractures in the rock formation. The fluid is predominately water, but may also include solids, such as sand or ceramic proppants, which at least partially fill the fractures and maintain the preferential flow paths.

When oil or other fluids are produced/recovered from the well, it may be desirable to remove sand or other solids from the produced fluid. Typically, a separator system is used, which may include one or more separation devices (“separators”), filters, screens, tanks, etc. The separator system is generally connected to a wellhead via pipes or tubing. The fluid thus flows from well, into the wellhead, and then to the separator system, where the solids are separated out. The solids may be stored in a tank and periodically removed, while the fluids may be further separated (e.g., to separate hydrocarbons from water). Recovered hydrocarbons may be stored or otherwise transported for sale, and recovered water may be stored or otherwise recirculated for use in the well.

The separators may be vortical flow or “cyclonic” separators that provide a vortical flow chamber therein. The particulate-laden fluids recovered from the well are introduced into this vortical flow chamber, generally through a tangential inlet. The vortical flow chamber typically has an opening in the top through which an outlet tube is received that extends into the vortical flow chamber. The lighter fluids exit up through this outlet tube. The separators also have an opening in the bottom, through which the heavier solids are received. The fluids received into the inlet may be at relatively high pressures and speed, and, since they include particulate matter such as sand, may be abrasive to the structure defining the vortical flow chamber and can lead to frequent maintenance requirements for the wellhead systems and relatively short lifecycles for the separators.

During the lifecycle of a well, the fluid flow rate of produced fluids may change. Often, the well begins at relatively low fluid flow rate, which becomes progressively higher over time, although wells having reducing flow rates are also common. In either such well, the changing fluid flow rate may affect the vortical flow in the separator, as either fluid flow rates that are too high or too low can decrease the efficiency of the separator. Differently sized, modular nozzles may be provided to adjust the velocity of the fluid. However, to swap out nozzles of different sizes, the separator generally has to be taken offline, which can interrupt production.

### SUMMARY

An adjustable inlet assembly for a separator is disclosed. The adjustable inlet assembly includes a nozzle positioned in an inlet of a cyclone housing. The adjustable inlet assembly also includes an inlet housing coupled to the cyclone housing and sealing therewith around the inlet. The adjustable inlet assembly also includes a movable rod disposed at least partially in the inlet housing. The movable rod is configured to move between a first position in which the movable rod at least partially obstructs fluid flow in the nozzle, and a second position in which the movable rod does not obstruct fluid flow in the nozzle.

A method is also disclosed. The method includes measuring a fluid flow rate of a fluid fed into a separator via a nozzle. The method also includes adjusting the fluid flow rate by moving a rod at least partially linearly into or out of a nozzle, so as to maintain a minimum velocity of fluid flow in the separator.

A separator system is also disclosed. The separator system includes a cyclonic separator. The separator system also includes a nozzle coupled to the cyclonic separator and configured to deliver fluid to the cyclonic separator in a generally tangential orientation. The separator system also includes an inlet housing coupled to the cyclonic separator. The nozzle is in communication with an interior of the inlet housing. The separator system also includes a rod positioned in the inlet housing and movable between a first position in which the rod partially but not entirely obstructs fluid flow through the nozzle, and a second position in which the rod does not obstruct fluid flow to or through the nozzle.

### BRIEF DESCRIPTION OF THE DRAWINGS

The present disclosure may best be understood by referring to the following description and the accompanying drawings that are used to illustrate embodiments of the invention. In the drawings:

FIG. 1 illustrates a perspective, sectional view of a separator system including an adjustable inlet assembly in a first configuration, according to an embodiment.

FIG. 2 illustrates a perspective, sectional view of the separator system including the adjustable inlet assembly in a second configuration, according to an embodiment.

FIG. 3 illustrates a perspective, sectional view of an end of the inlet assembly communicating with an internal chamber of the separator system, according to an embodiment.

FIG. 4 illustrates a perspective view of a nozzle and an end of an adjustment rod of the inlet assembly, according to an embodiment.

FIG. 5 illustrates a side view of the nozzle and the end of the adjustment rod of the inlet assembly, according to an embodiment.

FIG. 6 illustrates a perspective view of the nozzle and the end of the adjustment rod, with the adjustment rod in an eccentric position, according to an embodiment.

FIG. 7 illustrates a side view of the nozzle and the end of the adjustment rod, with the adjustment rod in the eccentric position, according to an embodiment.

FIG. 8 illustrates a perspective view of the nozzle and an end of another adjustment rod, according to an embodiment.

FIG. 9 illustrates an end view of the nozzle and the end of the adjustment rod of FIG. 10, according to an embodiment.

FIG. 10 illustrates a flowchart of a method for operating a separator system, according to an embodiment.

### DETAILED DESCRIPTION

The following disclosure describes several embodiments for implementing different features, structures, or functions of the invention. Embodiments of components, arrangements, and configurations are described below to simplify the present disclosure; however, these embodiments are provided merely as examples and are not intended to limit the scope of the invention. Additionally, the present disclosure may repeat reference characters (e.g., numerals) and/or letters in the various embodiments and across the Figures provided herein. This repetition is for the purpose of simplicity and clarity and does not in itself dictate a relationship between the various embodiments and/or configurations discussed in the Figures. Moreover, the formation of a first feature over or on a second feature in the description that follows may include embodiments in which the first and second features are formed in direct contact, and may also include embodiments in which additional features may be formed interposing the first and second features, such that the first and second features may not be in direct contact. Finally, the embodiments presented below may be combined in any combination of ways, e.g., any element from one exemplary embodiment may be used in any other exemplary embodiment, without departing from the scope of the disclosure.

Additionally, certain terms are used throughout the following description and claims to refer to particular components. As one skilled in the art will appreciate, various entities may refer to the same component by different names, and as such, the naming convention for the elements described herein is not intended to limit the scope of the invention, unless otherwise specifically defined herein. Further, the naming convention used herein is not intended to distinguish between components that differ in name but not function. Additionally, in the following discussion and in the claims, the terms “including” and “comprising” are used in an open-ended fashion, and thus should be interpreted to mean “including, but not limited to.” All numerical values in this disclosure may be exact or approximate values unless otherwise specifically stated. Accordingly, various embodiments of the disclosure may deviate from the numbers, values, and ranges disclosed herein without departing from the intended scope. In addition, unless otherwise provided herein, “or” statements are intended to be non-exclusive; for example, the statement “A or B” should be considered to mean “A, B, or both A and B.”

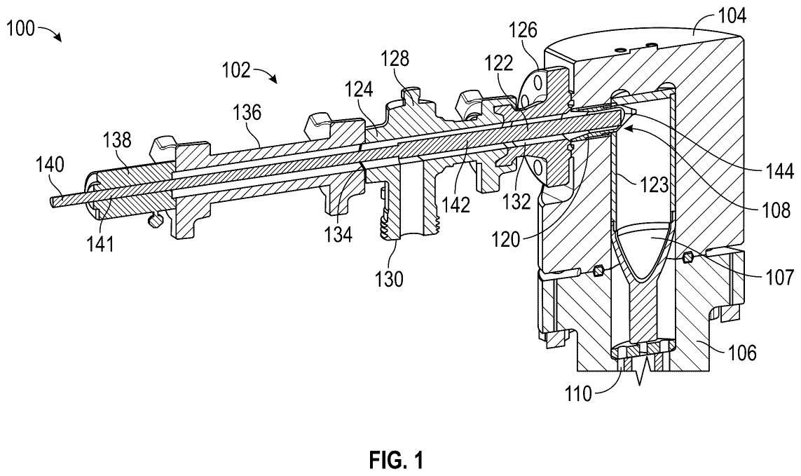

FIG. 1 illustrates a perspective, sectional view of a separator system 100 including an adjustable inlet assembly 102, according to an embodiment. The separator system 100 may also include a cyclone housing 104 that defines an internal chamber therein, and an accumulator 106 that is connected to and positioned below the cyclone housing 104. A cyclone 107 may be positioned at least partially in the internal chamber of the cyclone housing 104 and, as shown, at least partially in the accumulator 106. Further, the cyclone housing 104 may include an (e.g., tangential) inlet 108, a first outlet 110, and a second outlet, which is not visible in this figure, but may extend upward through the cyclone housing 104. In at least some embodiments, a fluid that carries a relatively high percentage of solids (e.g., sand) may be received into the inlet 108. The cyclone 107 may induce a vortical flow, which may force higher-density materials to flow to the radial outside, and lower-density materials to flow toward the center. The higher density materials (e.g., the sand) may eventually fall downward, through the first outlet 110 and into the accumulator 106, while the lower-density materials (e.g., fluids having a relatively lower percentage of solids) may proceed upward through the cyclone 107 and out the second outlet.

The inlet assembly 102 may be connected to the inlet 108 and may be configured to deliver fluid thereto for separation in the cyclone 107. The inlet assembly 102 may include a nozzle 120 and a movable rod 122. The nozzle 120 may be received into the cyclone housing 104, specifically the inlet 108 and oriented to deliver fluid into the cyclone housing 104 in a generally tangential direction. Further, the nozzle 120 may be profiled so as to follow the shape of a cylindrical/circumferential inner surface 123 of the cyclone housing 104, such that the nozzle 120 does not protrude into the inner chamber of the cyclone housing 104 or otherwise disrupt the vortical flow of fluid induced by the cyclone 107. In at least some embodiments, the nozzle 120 may be easily removed/inserted in the inlet 108. This may permit a modular design, in which a variety of different nozzle sizes, shapes, etc. may be provided, e.g., as a kit, and from which an operator may select the nozzle 120 based on a variety of factors, such as volumetric fluid flow rate and a target velocity in the cyclone housing 104.

The inlet assembly 102 may also include an inlet housing 124 that may be connected to an exterior of the cyclone housing 104. The inlet housing 124 may include a flange 126 that connects directly to the cyclone housing 104, e.g., around the inlet 108, and seals with the cyclone housing 104, such that the nozzle 120 is in communication with the interior of the inlet housing 124. Specifically, the flange 126 may be sized and configured to permit fluid communication therethrough to the inlet 108, while holding the nozzle 120 within the inlet 108. The inlet housing 124 may also include a T-connection 128, which may be coupled to the flange 126. The T-connection 128 may have a first port 130 that is configured to receive the fluid flow therethrough, and may be disposed at a non-zero angle, e.g., a 90-degree angle, to the inlet 108. The T-connection 128 may also have a second port 132 that faces toward, and parallel to, the inlet 108, e.g., at a 90 degree angle to the first port 130. The fluid flow received in the first port 130 may be directed within the T-connection 128 to the second port 132. The T-connection 128 may further have a third port 134 that is also oriented parallel to the inlet 108. The movable rod 122, in the illustrated first position, extends through the second and third ports 132, 134, past the first port 130, and into the nozzle 120.

The inlet housing 124 may also include a cylindrical extension 136, which may be attached to or integral with the T-connection 128. The cylindrical extension 136 may be hollow, and the movable rod 122 may extend therethrough. The cylindrical extension 136 may be sized to permit the movable rod 122 to be moved laterally from within the T-connection 128, without being completely removed from the inlet housing 124, as will be described in greater detail below. A packing seal 138 may be connected to the cylindrical extension 136 (or directly to the T-connection 128, in some embodiments). The packing seal 138 may receive the movable rod 122 therethrough, such that the movable rod 122, in some embodiments, may be partially within the sealed, pressurized inlet housing 124, and partially extending outward therefrom.

The inlet assembly 102 may also include an actuator (not shown) that moves the movable rod 122 relative to the nozzle 120. The actuator may be a threaded connection that engages a proximal end 140 of the movable rod 122 and the inlet housing 124, such that rotating actuator, and potentially the movable rod 122 therewith, advances or retracts the movable rod 122 into/out of the nozzle 120 while the inlet housing 124 remains stationary. The actuator may also be a rack-and-pinion. In such an embodiment, the rack portion of the actuator may be fixed to the proximal end 140 of the movable rod 122 and may be moved through the packing seal 138 by rotating the pinion, or the rack could be entirely external to the packing seal 138. In another embodiment, the actuator may be a hydraulic cylinder that acts on the movable rod 122. In other embodiments, the actuator may be an electrical actuator, such as a solenoid. A variety of other actuators could also be used to impart controlled linear movement of the movable rod 122 relative to the nozzle 120, as will be described in greater detail below.

In an embodiment, the movable rod 122 may include a first section 141 and a second section 142. The first section 141 may have a smaller diameter than the second section 142. The first section 141 may thus fit through the packing seal 138, while the second section 142 may not. Accordingly, at least the second section 142 may remain within the inlet housing 124, while at least a portion of the first section 141 may be configured to extend out from the inlet housing 124. In an embodiment, the first section 141 may extend from the proximal end 140 of the movable rod 122, and the second section 142 may extend to a distal end 144 of the movable rod 122, with the distal end 144 of the movable rod 122 being positionable in the nozzle 120, as shown. In various embodiments, the movable rod 122 may be solid, as shown, or at least partially hollow, e.g., to reduce the force required to move the rod 122. In at least some embodiments, the distal end 144 of the rod 122 may include a bore or hole.

In the illustrated view, as mentioned above, the movable rod 122 is in the first position. In the first position, the movable rod 122 partially obstructs fluid flow between the first port 130 of the T-connection 128 and the inlet 108. In particular, the second section 142 may extend through the second and third ports 132, 134 and the nozzle 120, such that the distal end 144 is even with or at least proximal to the inner surface 123 of the cyclone housing 104. Since the movable rod 122 occupies part of the cross-sectional area of the nozzle 120, the movable rod 122 reduces the flow path area, thereby increasing the fluid flow velocity in the nozzle 120. Furthermore, at least a portion of the movable rod 122 proximal to the distal end 144 may include an abrasive texture, fins, or other structures that impact fluid flow therepast, so as to permit further adjustment of the fluid flow.

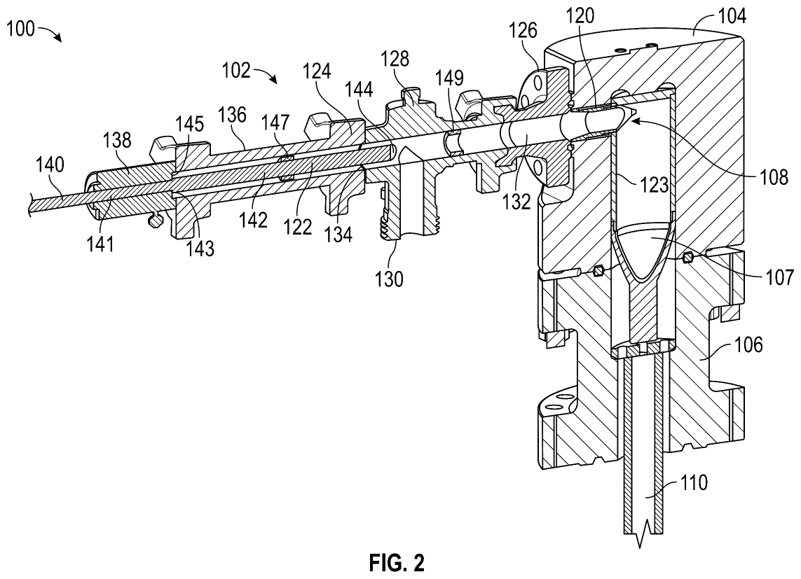

FIG. 2 illustrates a perspective, sectional view of the separator system 100 including the adjustable inlet assembly 102, according to an embodiment. In this view, the movable rod 122 has been moved axially away from the nozzle 120 to a second position, where the movable rod 122 is no longer in the nozzle 120. Moreover, the movable rod 122 may be pulled past the first port 130 of the T-connection 128, such that the movable rod 122 does not obstruct fluid flow through the T-connection 128 to the inlet 108. Accordingly, fluid may flow through the entire cross-section of the T-connection 128 between the first port 130 and the second port 132, within the flange 126, and through the nozzle 120.

The movable rod 122 may be moved by the actuator, as mentioned above. The position and angular orientation of the movable rod 122 in the inlet housing 124 may be controlled, such that its distal end 144 does not extend into the cyclone 107, past the inner surface 123. Accordingly, in an embodiment in which the actuator is a threaded connection between the housing 124 and the movable rod 122, an angular position indicator may be provided on the movable rod 122, e.g., a clock mark, that may permit a user to properly align the movable rod 122 within the inlet housing 124.

In at least some embodiments, the proximal end 140 of the movable rod 122 and a portion of the rod 122 extending therefrom may include markings that provide a visual indication of how far out of the inlet housing 124 that the rod 122 extends. Accordingly, the position of the rod 122 relative to the inlet housing 124, and thus relative to the nozzle 120 may be determinable by visual inspection from the exterior of the separator system 100, without disassembly of any part thereof. In some embodiments, optical sensors may recognize the markings to determine the position of the rod 122 automatically and/or other types of sensors (e.g., LVDT sensors, actuator encoders, etc.) may be employed to provide position feedback for the location of the rod 122. In such embodiments including such sensors, an actuator and controller pairing may be used to automatically adjust a location of the movable rod 122, e.g., based on a desired fluid flow rate.

Further, in at least some embodiments, the inlet housing 124 and/or the movable rod 122 may optionally include one or more stop “features” that prevent movement of the movable rod 122 relative to the inlet housing 124 in at least one direction, and thereby prevent unintended displacement of the movable rod 122 relative to the nozzle 120. For example, the inlet housing 124 may include restrictions that interact with the movable rod 122, e.g., one or more shoulders thereof, to limit movement of the rod 122 relative to the inlet housing 124. For example, the transition between the first and second portions 141, 142 may provide such a shoulder 143, and the inlet housing 124 may provide a restriction 145 between the cylindrical extension 136 and the packing seal 138 through which the shoulder 143 cannot pass. Thus, once the shoulder 143 engages the restriction 145, further movement of the rod 122 away from the nozzle 120 may be prevented. Likewise, the rod 122 may include a shoulder 147 and the inlet housing 124 may include a restriction 149. The shoulder 147 may engage the restriction 149 and may not pass therethrough, thereby limiting the travel of the rod 122 into the nozzle 120. In some embodiments, a pin and hole may be used to secure the position of the rod 122. For example, when aligned in the first position, holes in the housing 124 and the movable rod 122 may align, and a pin may be inserted to prevent movement therebetween. Likewise, holes in the housing 124 and the movable rod 122 may be aligned when the movable rod 122 is in the second position, permitting insertion of a pin to secure the position of the movable rod 122. These optional stops/restrictions, pins/holes, etc. may be employed, e.g., in embodiments in which the movable rod 122 is configured to be moved manually.

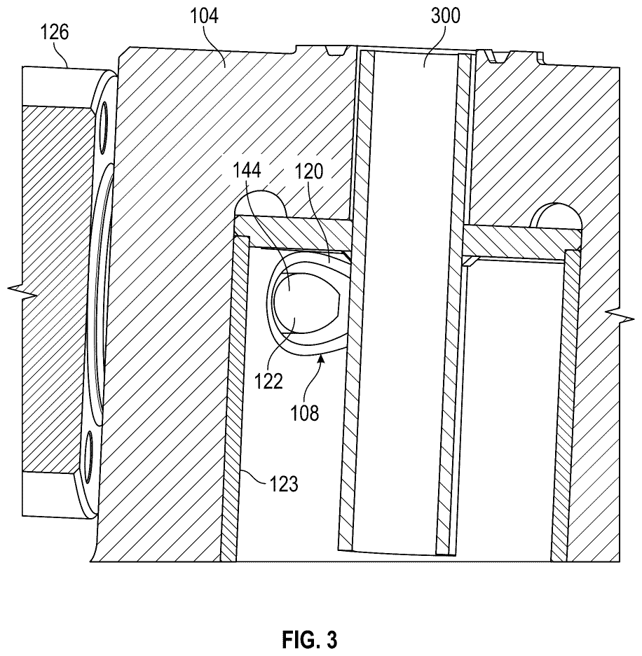

FIG. 3 illustrates a sectional view of a portion of the separator system 100, in particular, the cyclone housing 104, from a different angle than the sectional views shown in FIGS. 1 and 2. In this view, the inlet 108 is shown formed in the inner surface 123 of the cyclone housing 104. The second outlet 300 is also shown in this view, through which the separated fluid may proceed out of the cyclone housing 104, after proceeding through the cyclone 107.

The nozzle 120 is positioned in the inlet 108, and is shaped and configured such that its end is flush with the inner surface 123. As such, the nozzle 120 may not interfere with the vortical flow in the cyclone housing 104. The movable rod 122 is also shown with its distal end 144 positioned in the nozzle 120, e.g., consistent with the first position of the movable rod 122 shown in FIG. 1. Moreover, the distal end 144 may be curved along the same radial dimension as the inner surface 123 and the nozzle 120, such that the distal end 144 may be even with the inner surface 123. In other words, in an embodiment, if the movable rod 122 were to be sized such that it entirely filled the nozzle 120, the movable rod 122 and nozzle 120 would fill the inlet 108 such that the inner surface 123 would be generally continuous. However, the movable rod 122 may not fill the nozzle 120 and may thus permit fluid flow therethrough.

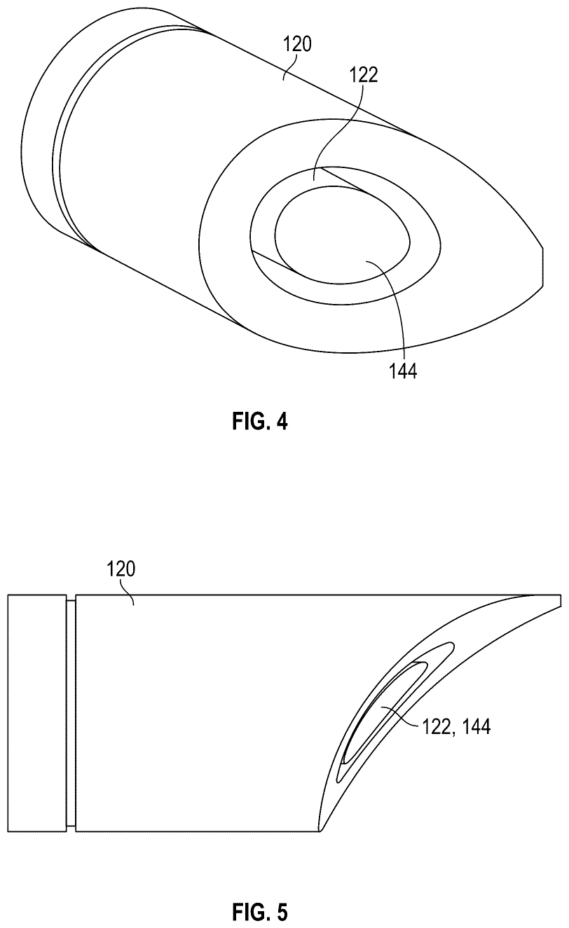

FIGS. 4 and 5 illustrate two additional views, showing the shape of the nozzle 120 and the distal end 144 of the movable rod 122 therein. As can be seen, when the movable rod 122 is fully received into the nozzle 120, the movable rod 122 does not extend past the nozzle 120, and thus does not extend into the cyclone 107 and disrupt the vortical flow in the cyclone 107.

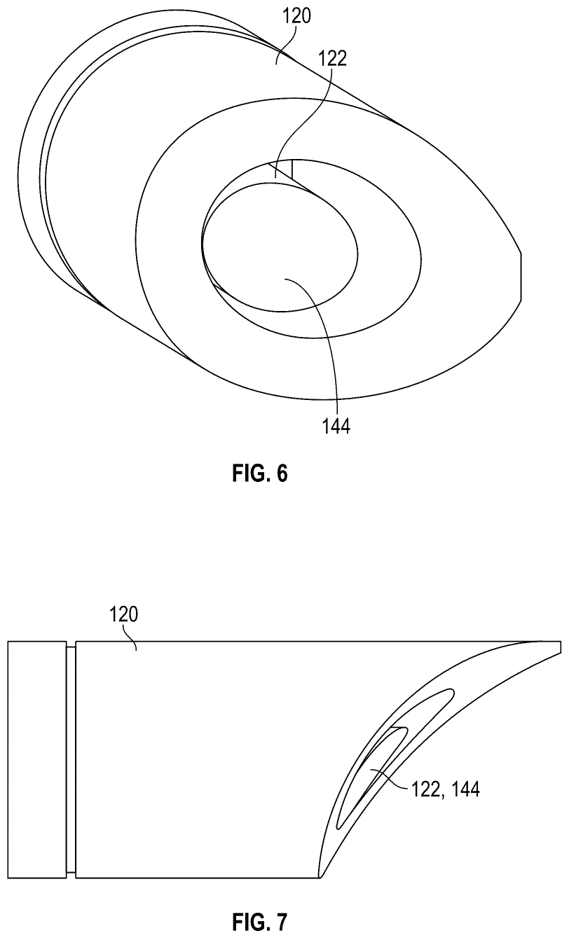

FIGS. 6 and 7 show two more views of the nozzle 120 receiving the distal end 144 of the movable rod 122 therein, according to an embodiment. As shown, the movable rod 122 may not be concentric with the nozzle 120. Rather, as shown, the movable rod 122 may be eccentrically disposed in the nozzle 120 to one side or the other. For example, the movable rod 122 may contact the inside of the nozzle 120, as shown.

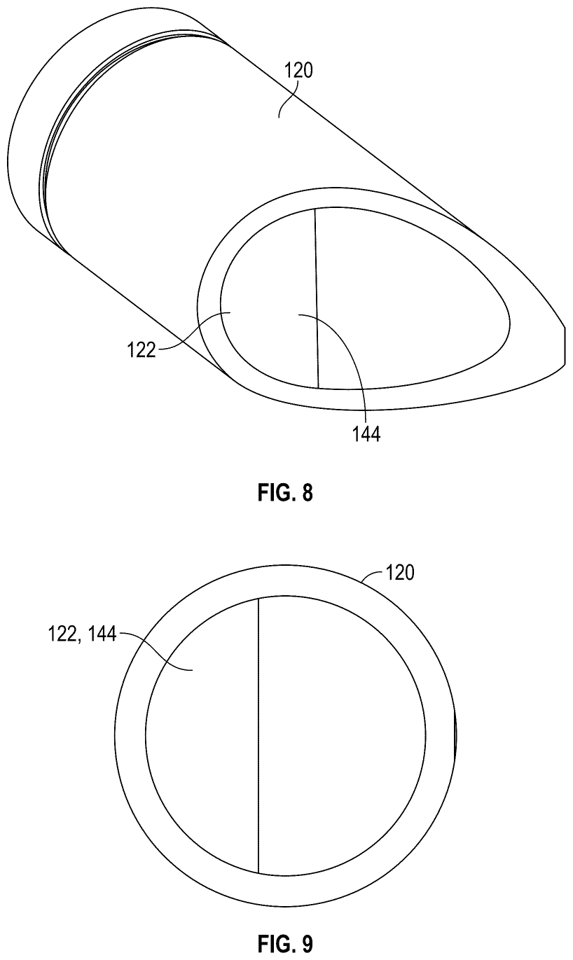

FIGS. 8 and 9 show two views of the nozzle 120 receiving the distal end 144 of another embodiment of the movable rod 122. The movable rod 122 may not be cylindrical, but may be another shape, e.g., semi-cylindrical or “half-moon” shaped. The movable rod 122 may, for example, have a curved surface that defines a radius that substantially matches the radius of the inner surface of the nozzle 120, so as to form a surface area of contact therebetween that substantially prevents fluid flow therebetween. The movable rod 122 may also have a flat surface that is spaced apart from the an inside surface of the nozzle 120 and thus permits fluid flow past the movable rod 122 and through the nozzle 120. It will be appreciated that the “flat” surface may have a rounded or otherwise profiled geometry, and need not be entirely straight. Accordingly, the fluid may flow through the space between the flat surface and the nozzle 120, which may prevent or at least reduce the introduction of eddy currents that may disrupt separation efficiency in the cyclone housing 104.

Moreover, embodiments of the adjustable inlet assembly 102 are contemplated in which two or more movable rods 122 may be movably disposed in the inlet housing 124. In some such embodiments, the multiple rods 122 may be movable independently of one another, such that the flow path area of the nozzle 120 may be modified by sliding one rod 122 into the nozzle 120, then removing the one rod 122 and sliding another (e.g., differently sized) rod 122 into the nozzle 120, and/or by sliding two or more rods 122 (of the same or different sizes) into the nozzle 120 at once. This may permit selection of two or more flow path areas through the nozzle 120. Further, the movable rod 122 may be tapered, stepped, or otherwise profiled such that its orientation and/or relative extension into the nozzle 120 results in different minimum flow path areas through the nozzle 120. As such, the movable rod 122 may be moved across a range of positions to provide a range of flow paths through the nozzle 120.

Further, the nozzle 120 may be selected from several nozzles of varying dimensions. The nozzle 120 may be inserted into and removed from the cyclone housing 104, e.g., to maintain a generally consistent fluid velocity in the cyclone 107 at a variety of different fluid flow (e.g., mass or volumetric flow) rates through the inlet 108. Different rods 122 may be provided for each differently sized nozzle 120, such that each nozzle 120 effectively provides two or more flow path areas, e.g., at least one with the rod 122 positioned therein and one without the rod 122 positioned therein. In other embodiments, a larger nozzle 120 may use the same movable rod 122 as a smaller nozzle 120. In other embodiments, a single movable rod 122 may be used with a smaller nozzle 120 and that movable rod 122 and one or more other rods 122 (of the same or different shape) may be used with the larger nozzle 120. In some embodiments, the nozzle 120 may be shaped or otherwise profiled such that insertion and withdrawal of the movable rod 122 into/out of the nozzle 120 modulates the flow path area through the nozzle 120 across a range of possible areas.

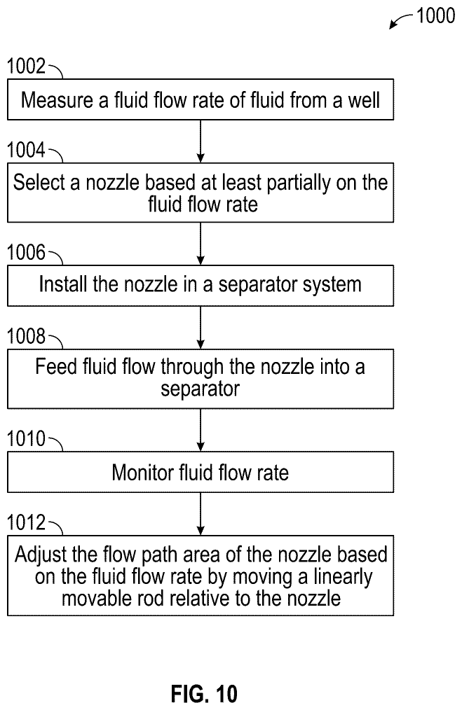

FIG. 10 illustrates a flowchart of a method 1000 for operating a separator system, according to an embodiment. The method 1000 may be executed using an embodiment of the separators system 100 discussed above, but in other embodiments, may use other devices, and thus is not limited to any particular structure unless otherwise stated herein. Further, the method 1000 may be executed in the order described below, or in any other order. The steps in the method 1000 may also be combined or performed in parallel, and/or individual steps may be broken into two or more steps.

Referring additionally to the embodiments of the separator system 100 of FIGS. 1-8, the method 1000 may employ the inlet assembly 102 to adjust the cross-sectional flow path area of the inlet 108 to the cyclone housing 104. In some cases, this may be accomplished without interrupting fluid flow to the cyclone housing 104 or the cyclone 107 therein, but may be accomplished while such fluid flow, and separation of sand therefrom, is ongoing.

In an embodiment, the method 1000 may include measuring (e.g., monitoring, sensing, etc.) a flow rate of fluid from a well to which the separator system 100 is, or is to be, connected, as at 1002. This may be determined, for example, during an initial production state, during testing, during use of the separator system 100, or at any other time. A nozzle 120 may be selected from a plurality of available nozzles of different sizes, shapes, etc., as at 1004, based at least partially on this fluid flow rate, e.g., to produce a desired vortical flow velocity in the cyclone 107. The nozzle 120 may be installed into the inlet 108 of the cyclone housing 104 of the separator system 100, as at 1006.

The method 1000 may then include feeding the fluid flow through the nozzle 120, as at 1008. At this stage, the movable rod 122 may be in the second position (FIG. 2), e.g., not obstructing fluid flow through the nozzle 120. In other embodiments, the movable rod 122 may begin in the first position (FIG. 1), such that it partially obstructs fluid flow through the nozzle 120, so as to initiate fluid flow at the desired velocity into the cyclone 107.

The fluid flow rate through the nozzle 120 may be monitored during operation, as at 1010, e.g., measured as flow into and out of the separator system 100. At some point, the fluid flow rate from the well may change, for example, diminish, which may lower the vortical velocity of the fluid in the cyclone 107, as the volumetric flowrate is lower, but the flow path area remains the same. The velocity may eventually be out of desired range, e.g., potentially impacting the separation efficiency of the separator system 100.

Accordingly, the velocity of the fluid in the cyclone 107 may be adjusted by adjusting the flow path area of the nozzle 120, as at 1012. To adjust the flow path area, the movable rod 122 may be moved, e.g., at least partially linearly (e.g., by sliding manually, using a linear actuator, or using a rotary actuator). For example, to increase the flow path area, the movable rod 122 may be withdrawn from the nozzle 120 to its second position (FIG. 2). To decrease the flow path area, the movable rod 122 may be advanced to its first position (FIG. 1).

The movable rod 122 may be moved automatically, for example, responsive to signals from a controller than is connected to an actuator and/or to sensors that sense velocity, volumetric flow rates, mass flow rates, rod 122 position, etc., as described above. In other embodiments, the movable rod 122 position may be manipulated manually, e.g., by rotating a threaded connection between the movable rod 122 and the inlet housing 124, energizing a hydraulic, mechanical, or electromechanical actuator, etc., and responsive to human-viewable gauges that indicate fluid flow rate, for example, and/or markings that indicate rod 122 position, for example.

In some embodiments, more than one movable rod 122 may be provided. Thus, for example, as flow rates continue to change from the well, a second movable rod 122 may be moved, e.g., while the first movable rod 122 remains stationary or is likewise moved, into or out of the nozzle 120. The second movable rod 122 may be adjacent to or positioned around the first movable rod 122. Further, the orientation of the movable rod 122 could be changed and/or the position modulated so as to increase or decrease the minimum flow path area through the nozzle 120.

The foregoing has outlined features of several embodiments so that those skilled in the art may better understand the present disclosure. Those skilled in the art should appreciate that they may readily use the present disclosure as a basis for designing or modifying other processes and structures for carrying out the same purposes and/or achieving the same advantages of the embodiments introduced herein. Those skilled in the art should also realize that such equivalent constructions do not depart from the spirit and scope of the present disclosure, and that they may make various changes, substitutions, and alterations herein without departing from the spirit and scope of the present disclosure.

What is claimed is:

1. An adjustable inlet assembly for a separator, comprising:
a nozzle positioned in an inlet of a cyclone housing;
an inlet housing coupled to the cyclone housing and sealing therewith around the inlet; and
a movable rod disposed at least partially in the inlet housing, wherein the movable rod is configured to move between a first position in which the movable rod at least partially obstructs fluid flow in the nozzle, and a second position in which the movable rod does not obstruct fluid flow in the nozzle.

2. The adjustable inlet assembly of claim 1, wherein the inlet of the cyclone housing is a tangential inlet, and wherein an end of the nozzle is curved so as to fit into the tangential inlet of the cyclone housing without extending into an internal chamber of the cyclone housing.

3. The adjustable inlet assembly of claim 2, wherein a distal end of the movable rod is curved so as to fit into the nozzle without extending into the internal chamber.

4. The adjustable inlet assembly of claim 1, further comprising an actuator configured to move the movable rod with respect to the inlet housing and the nozzle.

5. The adjustable inlet assembly of claim 4, wherein the actuator comprises a hydraulic actuator, a threaded connection with the inlet housing, a rack-and-pinion, or a combination thereof.

6. The adjustable inlet assembly of claim 1, wherein at least a portion of the movable rod has a semi-cylindrical shape having a curved surface and a flat surface, the curved surface being configured to contact an inside surface of the nozzle and the flat surface being spaced apart from the inside surface.

7. The adjustable inlet assembly of claim 1, wherein the inlet housing comprises a T-connection having a first port configured to receive a fluid therein, a second port configured to deliver the fluid from the first port to the nozzle, and a third port, wherein the first port is disposed at a non-zero angle to the second and third ports, and wherein the second and third ports are parallel to one another and to the nozzle.

8. The adjustable inlet assembly of claim 7, wherein the movable rod in the first position extends through the second and third ports and past the first port, and wherein the movable rod in the second position does not extend past the first port.

9. The adjustable inlet assembly of claim 7, wherein the inlet housing comprises a cylindrical extension coupled to the T-connection such that the T-connection is between the cyclone housing and the cylindrical extension, the movable rod being at least partially disposed in the cylindrical extension in the first position and in the second position.

10. The adjustable inlet assembly of claim 9, wherein the inlet housing further comprises a packing seal that is coupled to the cylindrical extension and seals with the movable rod, wherein a first portion of the movable rod is within the inlet housing, and a second portion is outside of the inlet housing, the movable rod extending between the first and second portions through the packing seal.

11. A method, comprising:
measuring a fluid flow rate of a fluid fed into a separator via a nozzle; and
adjusting the fluid flow rate by moving a rod at least partially linearly into or out of a nozzle, so as to maintain a minimum velocity of fluid flow in the separator.

12. The method of claim 11, wherein the rod is received at least partially through a port of an inlet housing that is connected to the nozzle, and wherein moving the rod comprises moving the rod between a first position in which the rod partially but not completely obstructs the port, the inlet housing between the port and the nozzle, and the nozzle, and a second position in which the rod does not obstruct fluid flow between the port and the nozzle.

13. The method of claim 11, wherein adjusting the fluid flow comprises feeding fluid to the separator while moving the rod.

14. The method of claim 11, wherein the rod comprises moving the rod comprises moving one rod relative to another rod into or out of the nozzle.

15. A separator system, comprising:
a cyclonic separator;
a nozzle coupled to the cyclonic separator and configured to deliver fluid to the cyclonic separator in a generally tangential orientation;
an inlet housing coupled to the cyclonic separator, the nozzle being in communication with an interior of the inlet housing; and
a rod positioned in the inlet housing and movable between a first position in which the rod partially but not entirely obstructs fluid flow through the nozzle, and a second position in which the rod does not obstruct fluid flow to or through the nozzle.

16. The separator system of claim 15, wherein an end of the nozzle is profiled to avoid protruding into the cyclonic separator, and wherein an end of the rod is profiled to avoid protruding inward through the nozzle and into the cyclonic separator.

17. The separator system of claim 16, wherein the inlet housing comprises a stop feature that blocks movement of the rod in at least one direction relative to the nozzle, so as to prevent the rod from displacement relative to the nozzle.

18. The separator system of claim 15, wherein the rod extends axially out of the inlet housing such that a position of the rod relative to the nozzle is determinable based on how far out of the inlet housing the rod extends.

19. The separator of claim 18, wherein the rod is sealed with the inlet housing to permit the rod to movable extend through the inlet housing in an axial direction.

20. The inlet housing of claim 15, wherein the inlet housing comprises a port that is radially oriented, wherein the nozzle is axially oriented relative to the inlet housing, and wherein port is position between the rod, when the rod is in the second position, and the nozzle, such that the rod in the second position does not obstruct fluid flow between the port and the nozzle.
